(19) United States
(12) Patent Application Publication
(10) Pub. No.: US 2015/0110262 A1
(43) Pub. Date: Apr. 23, 2015

(54) Method and Apparatus for Controlling Call Audio Channel on Communications Terminal, and Communications Terminal

(71) Applicant: Huawei Device Co., Ltd., Shenzhen (CN)

(72) Inventor: Gang Wu, Shanghai (CN)

(21) Appl. No.: 14/584,712

(22) Filed: Dec. 29, 2014

Related U.S. Application Data
(63) Continuation of application No. PCT/CN2014/072088, filed on Feb. 14, 2014.

(30) Foreign Application Priority Data
Feb. 25, 2013 (CN) 201310059051.7

(51) Int. Cl. H04M 1/60

(52) U.S. Cl. CPC H04M 1/6033
USPC 379/387.01

(57) ABSTRACT

The present invention is applicable to the field of communications technologies, and provides a method and apparatus for controlling a call audio channel on a communications terminal, and a communications terminal. In the method, first, a voice signal received by a microphone of audio devices connected to a communications terminal is detected, where the audio devices include an internal audio device and at least one external audio device; then, an audio device with a received voice signal meeting a preset condition is selected as a target audio device; finally, the target audio device is set as a current call audio channel. In this way, a user neither needs to remember an audio device that has been connected nor needs to manually switch to a desired call audio channel, which brings convenience to the user.

This application claims the benefit of International Application No. PCT/CN2014/072088, filed on Feb. 14, 2014, which claims priority to Chinese Patent Application No. 201310059051.7, filed on Feb. 25, 2013 whose applications are hereby incorporated by reference.

### TECHNICAL FIELD

The present invention pertains to the field of communications technologies, and in particular, relates to a method and apparatus for controlling a call audio channel on a communications terminal, and a communications terminal.

### BACKGROUND

At present, if one or more external audio devices (for example, a headset) are connected to a communications terminal in a call, a current call audio channel is used by default according to a certain rule in the call. For example, if a Bluetooth headset is connected to the communications terminal, a call is made by using the Bluetooth headset by default; if a wired headset is connected to the communications terminal, a call is made by using the wired headset by default. When a user forgets that the Bluetooth headset has been connected to the communications terminal, and the user would like to directly use an internal audio device of the communications terminal to make a call, the internal audio device of the communications terminal cannot be used normally to make the call. In this case, it is necessary to manually switch a default call audio channel to a desired call audio channel.

### SUMMARY

An objective of embodiments of the present invention is to provide a method for controlling a call audio channel on a communications terminal, so as to resolve a problem in prior art that a call audio channel needs to be switched manually.

According to a first aspect, a method for controlling a call audio channel on a communications terminal is provided, including:

detecting a voice signal received by a microphone of audio devices connected to the communications terminal, where the audio devices include an internal audio device and at least one external audio device;

selecting an audio device with a received voice signal meeting a preset condition as a target audio device; and

setting the target audio device as a current call audio channel.

With reference to the first aspect, in a first possible implementation manner, the detecting a voice signal received by a microphone of audio devices connected to the communications terminal includes detecting a voice signal that is received within a preset period of time by a microphone of the audio devices connected to the communications terminal.

With reference to the first aspect or the first possible implementation manner of the first aspect, in a second possible implementation manner, the selecting an audio device with a received voice signal meeting a preset condition as a target audio device includes selecting an audio device with a strongest received voice signal as the target audio device.

With reference to the first aspect or the first possible implementation manner of the first aspect, in a third possible implementation manner, if the audio devices include an internal audio device and an external audio device, the selecting an audio device with a received voice signal meeting a preset condition as a target audio device includes:

comparing a voice signal received by a microphone of the external audio device of the communications terminal with a voice signal received by a microphone of the internal audio device of the communications terminal; and if a proportion of a strength difference between the two voice signals to a smaller strength value is greater than a preset value, selecting an audio device with a greater received voice signal strength value as the target audio device.

With reference to the first aspect or the first possible implementation manner of the first aspect, in a fourth possible implementation manner, if the audio devices include an internal audio device and more than two external audio devices, the selecting an audio device with a received voice signal meeting a preset condition as a target audio device includes:

selecting voice signals of two audio devices with strength of received voice signals ranked top two among the audio devices; and

if a proportion of a difference between two selected voice signals to a smaller strength value is greater than a preset value, selecting an audio device with a greatest received voice signal strength value as the target audio device.

With reference to the first aspect or any possible implementation manner of the first aspect, in a fifth possible implementation manner, the method further includes: generating a voice prompt or a text prompt.

According to a second aspect, an apparatus for controlling a call audio channel on a communications terminal is provided, where the apparatus includes:

a detecting unit, configured to detect a voice signal received by a microphone of audio devices connected to the communications terminal, where the audio devices include an internal audio device and at least one external audio device;

a selecting unit, configured to select an audio device with a received voice signal meeting a preset condition as a target audio device; and

a setting unit, configured to set the target audio device as a current call audio channel.

With reference to the second aspect, in a first possible implementation manner, the detecting unit is specifically configured to detect a voice signal that is received within a preset period of time by a microphone of the audio devices connected to the communications terminal.

With reference to the second aspect or the first possible implementation manner of the second aspect, in a second possible implementation manner, the selecting unit is specifically configured to select an audio device with a strongest received voice signal as the target audio device.

With reference to the second aspect or the first possible implementation manner of the second aspect, in a third possible implementation manner, if the audio devices include an internal audio device and an external audio device, the selecting unit is specifically configured to compare a voice signal received by a microphone of the external audio device of the communications terminal with a voice signal received by a microphone of the internal audio device of the communications terminal; and if a proportion of a strength difference between the two voice signals to a smaller strength value is greater than a preset value, select an audio device with a greater received voice signal strength value as the target audio device.

With reference to the second aspect or the first possible implementation manner of the second aspect, in a fourth possible implementation manner, if the audio devices include an internal audio device and more than two external audio devices, the selecting unit is specifically configured to select voice signals of two audio devices with strength of received voice signals ranked top two among the audio devices; and if a proportion of a difference between two selected voice signals to a smaller strength value is greater than a preset value, select an audio device with a greatest received voice signal strength value as the target audio device.

With reference to the second aspect or any possible implementation manner of the second aspect, in a fifth possible implementation manner, the apparatus further includes a prompt unit, configured to generate a voice prompt or a text prompt.

In the embodiments of the present invention, first, a voice signal received by a microphone of audio devices connected to a communications terminal is detected, where the audio devices include an internal audio device and at least one external audio device; then, an audio device with a received voice signal meeting a preset condition is selected as a target audio device; finally, the target audio device is set as a current call audio channel. In this way, a user neither needs to remember an audio device that has been connected nor needs to manually switch to a desired call audio channel, which brings convenience to the user.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is an implementation flowchart of a method for controlling a call audio channel on a communications terminal according to an embodiment of the present invention;

FIG. 2 is an architecture diagram of an apparatus for controlling a call audio channel on a communications terminal according to an embodiment of the present invention; and

FIG. 3 is a schematic diagram of structural composition of a communications terminal according to an embodiment of the present invention.

### DETAILED DESCRIPTION OF ILLUSTRATIVE EMBODIMENTS

In the embodiments of the present invention, first, a voice signal received by a microphone of audio devices connected to a communications terminal is detected, where the audio devices include an internal audio device and at least one external audio device; then, an audio device with a received voice signal meeting a preset condition is selected as a target audio device; finally, the target audio device is set as a current call audio channel. In this way, a user neither needs to remember an audio device that has been connected nor needs to manually switch to a desired call audio channel, which brings convenience to the user.

The following gives a detailed description of implementation of the present invention with reference to specific embodiments.

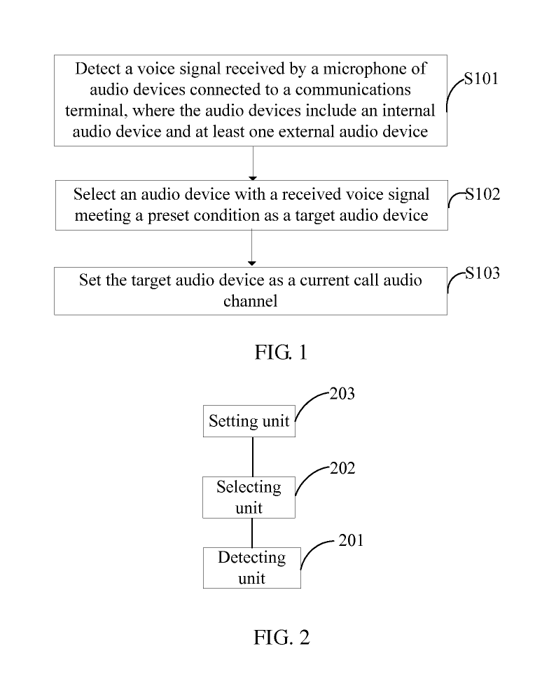

FIG. 1 shows an implementation flowchart of a method for controlling a call audio channel on a communications terminal according to this embodiment of the present invention, which is described in detail as follows:

In step S101, a voice signal received by a microphone of audio devices connected to the communications terminal is detected, where the audio devices include an internal audio device and at least one external audio device.

Generally, besides a built-in audio device (that is, an internal audio device), a communications terminal (for example, a mobile phone) is further equipped with one or more external audio devices. The internal audio device of the communications terminal and the external audio device of the communications terminal both include a microphone and an earpiece. The external audio device is a wired headset or/and a wireless headset (for example, a Bluetooth headset) connected to the communications terminal; that is, an individual wired headset or an individual wireless headset may be connected to the communications terminal, and both a wired headset and a wireless headset may also be connected to the communications terminal.

In this embodiment of the present invention, a voice signal received by a microphone of the audio devices connected to the communications terminal is detected. Because a sound signal received by a microphone is generally noisy, voice volume detection is enabled at this time, no matter which audio device is used as a call audio channel. In addition, once a call audio channel is manually switched in a call, the automatic detection function is disabled in the call, a channel is not automatically switched, and interaction is performed according to a call audio channel set by a user. In this way, confusion is avoided, so that manual switching and automatic switching of a call audio channel do not interfere with each other, and practicality is strong.

Optionally, a voice signal that is received within a preset period of time by a microphone of the audio devices connected to the communications terminal (for example, 2 s or 3 s) is detected. In this way, it is necessary to detect a voice signal received by each microphone in a period of time (for example, 2 s or 3 s), so as to avoid switching of a call audio channel when another audio device has a very short voice input. For example, switching is performed only when a voice signal remains stronger than a voice signal received by another audio device within 2 s, thereby avoiding a misjudgment.

It should be noted that when a terminal has a function of identifying noise, a voice signal received by a microphone in this method refers to voice information from which noise is removed, that is, voice information input by a user. In this way, a target audio device may be determined more accurately.

It should be noted that a current noise reduction technology may identify a difference between a voice and noise, and an identification rate of a voice may be continually improved by using a learning function. For example, an 80 dB sound signal may differentiate into a 50 dB voice and 30 dB noise.

In step S102, an audio device with a received voice signal meeting a preset condition is selected as a target audio device.

In this embodiment of the present invention, the audio device in which the received voice signal meets the preset condition is selected as the target voice device, where the target audio device may be an audio device with a strongest received voice signal. For example, a voice signal received by a microphone of the external audio device of the communications terminal is 30 dB, and a voice signal received by a microphone of the internal audio device of the communications terminal is 50 dB; then, the internal audio device is selected as the target audio device.

Optionally, if the audio devices include an internal audio device and an external audio device (that is, only one headset is connected), the selecting the audio device in which the received voice signal meets the preset condition as the target audio device includes: comparing a voice signal received by a microphone of the external audio device of the communications terminal with a voice signal received by a microphone of the internal audio device of the communications terminal; and if a proportion of a strength difference between the two voice signals to a smaller strength value is greater than a preset value (for example, 10% or 20%), selecting an audio device with a greater received voice signal strength value as the target audio device. In this way, only when a difference between strength values of the two voice signals is greater, the audio device with the greater received voice signal strength value is selected as the target audio device. If the proportion of the strength difference between the two voice signals to the smaller strength value is less than or equal to the preset value (for example, 10% or 20%), an original call audio channel is maintained (that is, a call is made by using a default call audio channel). That is, if strength values of voice signals that act on two call audio channels are approximate, the original call audio channel is maintained (that is, the call is made by using the default call audio channel), which can also avoid a misjudgment.

Optionally, if the audio devices include an internal audio device and more than two external audio devices (for example, a wireless headset and a wired headset are connected at the same time), the selecting the audio device in which the received voice signal meets the preset condition as the target audio device includes: selecting voice signals of two audio devices with strength of received voice signals ranked top two among the audio devices; and if a proportion of a difference between two selected voice signals to a smaller strength value is greater than a preset value (for example, 10% or 20%), selecting an audio device with a greatest received voice signal strength value as the target audio device. In this way, two voice signals with greater strength values are first selected; only when a difference between the strength values of the two voice signals is greater, the audio device with the greater received voice signal strength value is selected as the target audio device. If the proportion of the strength difference between the two voice signals to the smaller strength value is less than or equal to the preset value (for example, 10% or 20%), an original call audio channel is maintained (that is, a call is made by using a default call audio channel). That is, if strength values of voice signals that act on two call audio channels are approximate, the original call audio channel is maintained (that is, the call is made by using the default call audio channel), which can also avoid a misjudgment.

Optionally, after a call audio channel is switched, a communications terminal may generate text prompt information and display the text prompt information on a screen of the communications terminal. The communications terminal may also generate voice prompt information and play the voice prompt information on a target call audio device, so that a user is prompted that the call audio channel has been switched to the target call audio device, thereby greatly improving usability of the communications terminal.

In step S103, the target audio device is set as a current call audio channel.

In this embodiment of the present invention, the target audio device is set as the current call audio channel; in this way, a user neither needs to remember an audio device that has been connected nor needs to manually switch to a desired call audio channel, which brings convenience to the user.

FIG. 2 shows an apparatus for controlling a call audio channel on a communications terminal according to this embodiment of the present invention, which is described in detail as follows: The apparatus includes a detecting unit 201, a selecting unit 202, and a setting unit 203, where the detecting unit 201 is configured to detect a voice signal received by a microphone of audio devices connected to the communications terminal, and the audio devices include an internal audio device and at least one external audio device; the selecting unit 202 is configured to select an audio device with a received voice signal meeting a preset condition as a target audio device; and the setting unit 203 is configured to set the target audio device as a current call audio channel.

Generally, besides a built-in audio device (that is, an internal audio device), a communications terminal (for example, a mobile phone) is further equipped with one or more external audio devices. The internal audio device of the communications terminal and the external audio device of the communications terminal both include a microphone and an earpiece. The external audio device is a wired headset or/and a wireless headset (for example, a Bluetooth headset) connected to the communications terminal; that is, an individual wired headset or an individual wireless headset may be connected to the communications terminal, and a wired headset and a wireless headset may also be connected to the communications terminal at the same time.

In this embodiment of the present invention, the detecting unit 201 disposed in the communications terminal detects a voice signal received by a microphone of the audio devices connected to the communications terminal. In this way, the voice signal received by the microphone is transmitted to the detecting unit 201, and voice signal strength is detected by the detecting unit 201. Because a sound signal received by a microphone is generally noisy, voice volume detection is enabled at this time, no matter which audio device is used as a call audio channel. In addition, once a call audio channel is manually switched in a call, the automatic detection function is disabled in the call, a channel is not automatically switched, and interaction is performed according to a call audio channel set by a user. In this way, confusion is avoided, so that manual switching and automatic switching of a call audio channel do not interfere with each other, and practicality is strong.

Optionally, a voice signal that is received within a preset period of time by a microphone of the audio devices connected to the communications terminal (for example, 2 s or 3 s) is detected by the detecting unit 201. In this way, it is necessary to detect a voice signal received by each microphone in a period of time (for example, 2 s or 3 s), so as to avoid switching of a call audio channel when another audio device has a very short voice input. For example, switching is performed only when a voice signal remains stronger than a voice signal received by another audio device within 2 s, thereby avoiding a misjudgment.

It should be noted that when a terminal has a function of identifying noise, a voice signal received by a microphone in this method refers to voice information from which noise is removed, that is, voice information input by a user. In this way, a target audio device may be determined more accurately.

It should be noted that a current noise reduction technology may identify a difference between a voice and noise, and an identification rate of a voice may be continually improved by using a learning function. For example, an 80 dB sound signal may differentiate into a 50 dB voice and 30 dB noise.

In this embodiment of the present invention, the selecting unit 202 may select an audio device with a strongest received voice signal as the target audio device. For example, a voice signal received by a microphone of the external audio device of the communications terminal is 30 dB, and a voice signal received by a microphone of the internal audio device of the communications terminal is 50 dB; then, the internal audio device is selected as the target audio device.

Optionally, if the audio devices include an internal audio device and an external audio device (that is, only one headset is connected), the selecting, by the selecting unit 202, the audio device in which the received voice signal meets the preset condition as the target audio device includes: comparing a voice signal received by a microphone of the external audio device of the communications terminal with a voice signal received by a microphone of the internal audio device of the communications terminal; and if a proportion of a strength difference between the two voice signals to a smaller strength value is greater than a preset value (for example, 10% or 20%), selecting an audio device with a greater received voice signal strength value as the target audio device. In this way, only when a difference between strength values of the two voice signals is greater, the audio device with the greater received voice signal strength value is selected as the target audio device. If the proportion of the strength difference between the two voice signals to the smaller strength value is less than or equal to the preset value (for example, 10% or 20%), an original call audio channel is maintained (that is, a call is made by using a default call audio channel). That is, if strength values of voice signals that act on two call audio channels are approximate, the original call audio channel is maintained (that is, the call is made by using the default call audio channel), which can also avoid a misjudgment.

Optionally, if the audio devices include an internal audio device and more than two external audio devices (for example, a wireless headset and a wired headset are connected at the same time), the selecting, by the selecting unit 202, the audio device in which the received voice signal meets the preset condition as the target audio device includes: selecting voice signals of two audio devices with strength of received voice signals ranked top two among the audio devices; and if a proportion of a difference between two selected voice signals to a smaller strength value is greater than a preset value (for example, 10% or 20%), selecting an audio device with a greatest received voice signal strength value as the target audio device. In this way, two voice signals with greater strength values are first selected; only when a difference between the strength values of the two voice signals is greater, the audio device with the greater received voice signal strength value is selected as the target audio device. If the proportion of the strength difference between the two voice signals to the smaller strength value is less than or equal to the preset value (for example, 10% or 20%), an original call audio channel is maintained (that is, a call is made by using a default call audio channel). That is, if strength values of voice signals that act on two call audio channels are approximate, the original call audio channel is maintained (that is, the call is made by using the default call audio channel), which can also avoid a misjudgment.

Optionally, the apparatus for controlling a call audio channel on a communications terminal further includes a prompt unit that is configured to generate a voice prompt or a text prompt. In this way, after a call audio channel is switched, a communications terminal may generate text prompt information and display the text prompt information on a screen of the communications terminal. The communications terminal may also generate voice prompt information and play the sound prompt information on a target call audio device, so that a user is prompted that the call audio channel has been switched to the target call audio device, thereby greatly improving usability of the communications terminal.

In this embodiment of the present invention, the setting unit 203 sets the target audio device as the current call audio channel; in this way, a user neither needs to remember an audio device that has been connected nor needs to manually switch to a desired call audio channel, which brings convenience to the user.

It should be noted that a specific operating principle of each forgoing unit is the same as the foregoing and is not repeatedly described herein. In addition, each unit in the foregoing apparatus for automatic switching of a call audio channel on a communications terminal may be a software unit, a hardware unit, or a unit combining software and hardware, where a software unit part may be stored in a computer readable storage medium, such as a ROM/RAM, a magnetic disk, or an optical disc.

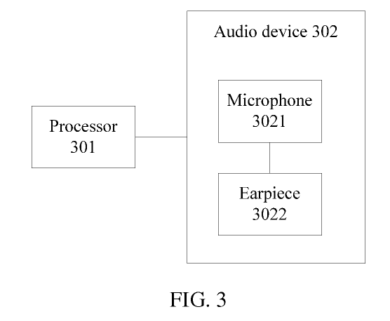

FIG. 3 is a schematic diagram of structural composition of a communications terminal according to an embodiment of the present invention, and the communications terminal includes a processor 301 and an audio device 302, where the audio device 302 includes a microphone 3021 and an earpiece 3022. The microphone 3021 is configured to receive a voice signal sent by a user and send the voice signal to the processor 301; and the earpiece 3022 is configured to receive the voice signal sent by the processor 301 and convert the voice signal into a sound.

It should be noted that the audio device 302 may include an internal audio device of the communications terminal and at least one external audio device, where the external audio device may include a wired headset and a wireless headset (for example, a Bluetooth headset).

The processor 301 is configured to receive a voice signal sent by a microphone of the audio device 302, where the audio device includes an internal audio device and at least one external audio device; the processor 301 is further configured to select an audio device with a received voice signal meeting a preset condition as a target audio device; the processor 301 is further configured to set the target audio device as a current call audio channel, and send an instruction to the target audio device 302, so that an earpiece 3022 and a microphone 3021 of the target audio device 302 are in a working state. That the earpiece 3022 and the microphone 3021 are in the working state means that a voice of a communications terminal user and a voice of a peer user are transmitted by using the earpiece and the microphone of the target audio device, and an earpiece and a microphone of another audio device are disabled.

Optionally, the processor 301 is further configured to receive a voice signal sent by a microphone of the audio device 302 in a preset period of time. In this way, it is necessary to detect a voice signal received by each microphone in a period of time (for example, 2 s or 3 s), so as to avoid switching of a call audio channel when another audio device has a very short voice input. For example, switching is performed only when a voice signal remains stronger than a voice signal received by another audio device within 2 s, thereby avoiding a misjudgment.

Optionally, the processor 301 is specifically configured to select an audio device with a strongest received voice signal as the target audio device. In this embodiment of the present invention, the processor 301 may select the audio device with the strongest received voice signal as the target audio device. For example, a voice signal received by a microphone of the external audio device of the communications terminal is 30 dB, and a voice signal received by a microphone of the internal audio device of the communications terminal is 50 dB; then, the internal audio device is selected as the target audio device.

Optionally, if the audio device includes an internal audio device and one external audio device, the processor 301 is specifically configured to compare a voice signal received by a microphone of the external audio device of the communications terminal with a voice signal received by a microphone of the internal audio device of the communications terminal; and if a proportion of a strength difference between the two voice signals to a smaller strength value is greater than a preset value, select an audio device with a greater received voice signal strength value as the target audio device. In this way, only when a difference between strength values of the two voice signals is greater, the audio device with the greater received voice signal strength value is selected as the target audio device. If the proportion of the strength difference between the two voice signals to the smaller strength value is less than or equal to the preset value (for example, 10% or 20%), an original call audio channel is maintained (that is, a call is made by using a default call audio channel). That is, if strength values of voice signals that act on two call audio channels are approximate, the original call audio channel is maintained (that is, the call is made by using the default call audio channel), which can also avoid a misjudgment.

Optionally, if the audio device includes an internal audio device and more than two external audio devices, the processor 301 is further configured to select voice signals of two audio devices with strength of received voice signals ranked top two among the audio devices; and if a proportion of a difference between two selected voice signals to a smaller strength value is greater than a preset value, select an audio device with a greatest received voice signal strength value as the target audio device. In this way, two voice signals with greater strength values are first selected; only when a difference between the strength values of the two voice signals is greater, the audio device with the greater received voice signal strength value is selected as the target audio device. If the proportion of the strength difference between the two voice signals to the smaller strength value is less than or equal to the preset value (for example, 10% or 20%), an original call audio channel is maintained (that is, a call is made by using a default call audio channel). That is, if strength values of voice signals that act on two call audio channels are approximate, the original call audio channel is maintained (that is, the call is made by using the default call audio channel), which can also avoid a misjudgment.

It should be noted that when a terminal has a function of identifying noise, a voice signal received by a microphone in this method refers to voice information from which noise is removed, that is, voice information input by a user. In this way, a target audio device may be determined more accurately.

It should be noted that a current noise reduction technology may identify a difference between a voice and noise, and an identification rate of a voice may be continually improved by using a learning function. For example, an 80 dB sound signal may differentiate into a 50 dB voice and 30 dB noise.

Optionally, the processor 301 is further configured to generate a voice prompt and send the voice prompt information to the earpiece 3022.

Optionally, the communications terminal further includes a display screen. The processor 301 is further configured to generate a text prompt and send the text prompt to the display screen; and the display screen is configured to display the text prompt generated by the processor 301. Therefore, a user is prompted that the call audio channel has been switched to the target call audio device, thereby greatly improving usability of the communications terminal.

In this embodiment of the present invention, the processor 301 sets the target audio device as the current call audio channel; in this way, a user neither needs to remember an audio device that has been connected nor needs to manually switch to a desired call audio channel, which brings convenience to the user.

The foregoing descriptions are merely exemplary embodiments of the present invention, but are not intended to limit the present invention. Any modification, equivalent replacement, or improvement made without departing from the spirit and principle of the present invention should fall within the protection scope of the present invention.

What is claimed is:

1. A method for controlling a call audio channel on a communications terminal, wherein the method comprises:
detecting a voice signal received by a microphone of audio devices connected to the communications terminal, wherein the audio devices comprise an internal audio device and at least one external audio device;
selecting an audio device with a received voice signal meeting a preset condition as a target audio device; and
setting the target audio device as a current call audio channel.

2. The method according to claim 1, wherein the detecting a voice signal received by a microphone of audio devices connected to the communications terminal comprises:
detecting a voice signal that is received within a preset period of time by a microphone of the audio devices connected to the communications terminal.

3. The method according to claim 2, wherein the selecting an audio device with a received voice signal meeting a preset condition as a target audio device comprises selecting an audio device with a strongest received voice signal as the target audio device.

4. The method according to claim 2, wherein the selecting an audio device with a received voice signal meeting a preset condition as a target audio device comprises:
comparing a first voice signal received by a microphone of the external audio device of the communications terminal with a second voice signal received by a microphone of the internal audio device of the communications terminal; and
selecting an audio device with a greater received voice signal strength value as the target audio device in response to a proportion of a strength difference between the first and second voice signals to a smaller strength value being greater than a preset value.

5. The method according to claim 2, wherein the audio devices comprise an internal audio device and more than two external audio devices; and
wherein the selecting an audio device with a received voice signal meeting a preset condition as a target audio device comprises:
selecting voice signals of two audio devices with strength of received voice signals ranked top two among the audio devices; and
selecting an audio device with a greatest received voice signal strength value as the target audio device in response to a proportion of a difference between two selected voice signals to a smaller strength value being greater than a preset value.

6. The method according to claim 1, wherein the selecting an audio device with a received voice signal meeting a preset condition as a target audio device comprises: selecting an audio device with a strongest received voice signal as the target audio device.

7. The method according to claim 1, wherein the selecting an audio device with a received voice signal meeting a preset condition as a target audio device comprises:
comparing a first voice signal received by a microphone of the external audio device of the communications terminal with a second voice signal received by a microphone of the internal audio device of the communications terminal; and
selecting an audio device with a greater received voice signal strength value as the target audio device in response to a proportion of a strength difference between the first and second voice signals to a smaller strength value being greater than a preset value.

8. The method according to claim 1, wherein the audio devices comprise an internal audio device and more than two external audio devices; and
wherein the selecting an audio device with a received voice signal meeting a preset condition as a target audio device comprises:
selecting voice signals of two audio devices with strength of received voice signals ranked top two among the audio devices; and
selecting an audio device with a greatest received voice signal strength value as the target audio device in response to a proportion of a difference between two selected voice signals to a smaller strength value being greater than a preset value.

9. The method according to claim 1, wherein the method further comprises generating a voice prompt or a text prompt.

10. An apparatus for controlling a call audio channel on a communications terminal, wherein the apparatus comprises:
a processor; and
a nontransitory computer readable storage medium connected to the processor and having stored thereon instructions for causing the processor to:
detect a voice signal received by a microphone of audio devices connected to the communications terminal, wherein the audio devices comprise an internal audio device and at least one external audio device;
select an audio device with a received voice signal meeting a preset condition as a target audio device; and
set the target audio device as a current call audio channel.

11. The apparatus according to claim 10, wherein the nontransitory computer readable storage medium further has stored thereon instructions for causing the processor to detect a voice signal that is received within a preset period of time by a microphone of the audio devices connected to the communications terminal.

12. The apparatus according to claim 11, wherein the nontransitory computer readable storage medium further has stored thereon instructions for causing the processor to select an audio device with a strongest received voice signal as the target audio device.

13. The apparatus according to claim 11, wherein the nontransitory computer readable storage medium further has stored thereon instructions for causing the processor to:
compare a first voice signal received by a microphone of the external audio device of the communications terminal with a second voice signal received by a microphone of the internal audio device of the communications terminal; and
select an audio device with a greater received voice signal strength value as the target audio device in response to a proportion of a strength difference between the first and second voice signals to a smaller strength value being greater than a preset value.

14. The apparatus according to claim 11, the audio devices comprise an internal audio device and more than two external audio devices; and
wherein the nontransitory computer readable storage medium further has stored thereon instructions for causing the processor to:
select voice signals of two audio devices with strength of received voice signals ranked top two among the audio devices; and
select an audio device with a greatest received voice signal strength value as the target audio device in response to a proportion of a difference between two selected voice signals to a smaller strength value being greater than a preset value.

15. The apparatus according to claim 11, wherein the nontransitory computer readable storage medium further has stored thereon instructions for causing the processor to generate a voice prompt or a text prompt.

16. The apparatus according to claim 10, wherein the nontransitory computer readable storage medium further has stored thereon instructions for causing the processor to select an audio device with a strongest received voice signal as the target audio device.

17. The apparatus according to claim 10, wherein the nontransitory computer readable storage medium further has stored thereon instructions for causing the processor to:
compare a first voice signal received by a microphone of the external audio device of the communications terminal with a second voice signal received by a microphone of the internal audio device of the communications terminal; and
select an audio device with a greater received voice signal strength value as the target audio device in response to a proportion of a strength difference between the first and second voice signals to a smaller strength value being greater than a preset value.

18. The apparatus according to claim 10, wherein the audio devices comprise an internal audio device and more than two external audio devices; and
wherein the nontransitory computer readable storage medium further has stored thereon instructions for causing the processor to:
select voice signals of two audio devices with strength of received voice signals ranked top two among the audio devices; and
select an audio device with a greatest received voice signal strength value as the target audio device in response to a proportion of a difference between two selected voice signals to a smaller strength value being greater than a preset value.
